(19) United States
(12) Patent Application Publication
(10) Pub. No.: US 2021/0352624 A1
(43) Pub. Date: Nov. 11, 2021

(54) INDICATION OF SINGLE OR MULTI-STAGE SIDELINK CONTROL INFORMATION (SCI)

(71) Applicant: QUALCOMM Incorporated, San Diego, CA (US)

(72) Inventors: Sony AKKARAKARAN, Poway, CA (US); Tao LUO, San Diego, CA (US); Jung Ho RYU, Fort Lee, NJ (US); Hua WANG, Basking Ridge, NJ (US); Junyi LI, Franklin Park, NJ (US)

(21) Appl. No.: 17/204,695

(22) Filed: Mar. 17, 2021

Related U.S. Application Data
(60) Provisional application No. 63/022,334, filed on May 8, 2020.

(51) Int. Cl. H04W 72/02; H04W 72/04; H04W 80/02; H04W 76/27

(52) U.S. Cl. CPC H04W 72/02; H04W 72/0406; H04W 76/27; H04W 80/02; H04W 72/0466

(57) ABSTRACT

Certain aspects of the present disclosure provide techniques for wireless communication by a first, transmitting, user equipment (UE) for sidelink communication with a second, receiving, UE. The techniques generally includes determining whether to transmit sidelink control information (SCI) for decoding a physical sidelink shared channel (PSSCH) transmission to a receiving UE in one or multiple stages, transmitting the SCI in accordance with the determination, and transmitting the PSSCH in accordance with the SCI. Release 16 NR sidelink transmissions often include two (or more) stages of SCIs. The present disclosure provides methods and techniques for alternative mechanisms to achieve similar goals as the multiple stages of SCIs when the second (and the subsequent) SCI stage(s) is absent.

### CROSS-REFERENCE TO RELATED APPLICATION

This application claims benefit of and priority to U.S. Provisional Patent Application No. 63/022,334, filed May 8, 2020, which is assigned to the assignee hereof and herein incorporated by reference in its entirety as if fully set forth below and for all applicable purposes.

### BACKGROUND

### Field of the Disclosure

Aspects of the present disclosure relate to wireless communications, and more particularly, to device-to-device sidelink communication.

### Description of Related Art

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

In some examples, a wireless multiple-access communication system may include a number of base stations (BSs), which are each capable of simultaneously supporting communication for multiple communication devices, otherwise known as user equipments (UEs). In an LTE or LTE-A network, a set of one or more base stations may define an eNodeB (eNB). In other examples (e.g., in a next generation, a new radio (NR), or 5G network), a wireless multiple access communication system may include a number of distributed units (DUs) (e.g., edge units (EUs), edge nodes (ENs), radio heads (RHs), smart radio heads (SRHs), transmission reception points (TRPs), etc.) in communication with a number of central units (CUs) (e.g., central nodes (CNs), access node controllers (ANCs), etc.), where a set of one or more DUs, in communication with a CU, may define an access node (e.g., which may be referred to as a BS, 5G NB, next generation NodeB (gNB or gNodeB), transmission reception point (TRP), etc.). A BS or DU may communicate with a set of UEs on downlink channels (e.g., for transmissions from a BS or DU to a UE) and uplink channels (e.g., for transmissions from a UE to BS or DU).

These multiple access technologies have been adopted in various telecommunication standards to provide a common protocol that enables different wireless devices to communicate on a municipal, national, regional, and even global level. NR (e.g., new radio or 5G) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

Sidelink communications are communications from one UE to another UE. As the demand for mobile broadband access continues to increase, there exists a need for further improvements in NR and LTE technology, including improvements to sidelink communications. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. Without limiting the scope of this disclosure as expressed by the claims that follow, some features will now be discussed briefly. After considering this discussion, and particularly after reading the section entitled “Detailed Description” one will understand how the features of this disclosure provide advantages that include improved device-to-device communications in a wireless network.

Certain aspects of this disclosure provide a method for wireless communication by a first, transmitting, user equipment (UE) for sidelink communication with a second, receiving, UE. The method generally includes determining whether to transmit sidelink control information (SCI) for decoding a physical sidelink shared channel (PSSCH) transmission to a receiving UE in one or multiple stages, transmitting the SCI in accordance with the determination, and transmitting the PSSCH in accordance with the SCI. Release 16 NR sidelink transmissions often include two (or more) stages of SCIs. The present disclosure provides methods and techniques for alternative mechanisms to achieve similar goals as the multiple stages of SCIs when the second (and the subsequent) SCI stage(s) is absent. For example, different schemes are disclosed herein to (1) indicate the number of SCI stages; and (2) to carry information of other SCI stages if they were available when they are actually absent. As such, by having a single stage SCI in some cases, unnecessary SCI overhead can be saved.

Certain aspects of this disclosure provide a method for wireless communication by a receiving UE. The method generally includes determining whether to receive sidelink control information (SCI) for decoding a physical side link shared channel (PSSCH) transmission from a transmitting UE in one or multiple stages, processing the SCI in accordance with the determination, and decoding the PSSCH in accordance with the SCI.

Certain aspects of this disclosure provide a method for wireless communication by a network entity. The method generally includes determining whether a first UE is to transmit sidelink control information (SCI) for decoding a physical side link shared channel (PSSCH) transmission to a second UE in one or multiple stages and providing, to at least one of the first UE or the second UE, an indication of whether the first UE is to transmit the SCI in one or multiple stages.

Aspects of the present disclosure provide means for, apparatus, processors, and computer-readable mediums for performing the methods described herein.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example telecommunications system, in accordance with certain aspects of the present disclosure.

FIG. 2 is a block diagram illustrating an example logical architecture of a distributed radio access network (RAN), in accordance with certain aspects of the present disclosure.

FIG. 3 is a diagram illustrating an example physical architecture of a distributed RAN, in accordance with certain aspects of the present disclosure.

FIG. 4 is a block diagram conceptually illustrating a design of an example base station (BS) and user equipment (UE), in accordance with certain aspects of the present disclosure.

FIGS. 5A and 5B show diagrammatic representations of example vehicle to everything (V2X) systems in accordance with some aspects of the present disclosure.

FIG. 6 illustrates an example of two-stage SCI for sidelink communications, in accordance with certain aspects of the present disclosure.

FIG. 7 illustrates example operations for wireless communications by a first, transmitting, UE, in accordance with certain aspects of the present disclosure.

FIG. 8 illustrates example operations for wireless communications by a second, receiving UE, in accordance with certain aspects of the present disclosure.

FIG. 9 illustrates example operations for wireless communications by a network entity, in accordance with certain aspects of the present disclosure.

FIG. 10 illustrates a communications device that may include various components configured to perform the operations illustrated in FIG. 7, in accordance with certain aspects of the present disclosure.

FIG. 11 illustrates a communications device that may include various components configured to perform the operations illustrated in FIG. 8, in accordance with certain aspects of the present disclosure.

FIG. 12 illustrates a communications device that may include various components configured to perform the operations illustrated in FIG. 9, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for determining and/or indicating one or multiple stages of sidelink control information (SCI). SCI in NR V2X of Release 16 can include two stages: SCI-1 and SCI-2. Decoding SCI-2 may need SCI-1; and decoding physical sidelink shared channel (PSSCH) may need both SCI-1 and SCI-2. The two-stage SCI design may (1) cause error propagation between the SCI-1 detection and the SCI-2 decoding; and (2) cost unnecessary SCI overhead, among other issues.

In some aspects of the present disclosure, the UE determine whether to transmit SCI for decoding PSSCH transmission in one or multiple stages and in some cases, transmit SCI in a single stage (e.g., SCI-1) and use alternative mechanisms to carry control or information that would have otherwise carried via other SCI stages (e.g., SCI-2).

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

The techniques described herein may be used for various wireless communication technologies, such as LTE, CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS).

New Radio (NR) is an emerging wireless communications technology under development in conjunction with the 5G Technology Forum (5GTF). 3GPP Long Term Evolution (LTE) and LTE-Advanced (LTE-A) are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, while aspects may be described herein using terminology commonly associated with 3G and/or 4G wireless technologies, aspects of the present disclosure can be applied in other generation-based communication systems, such as 5G and later, including NR technologies.

New radio (NR) access (e.g., 5G technology) may support various wireless communication services, such as enhanced mobile broadband (eMBB) targeting wide bandwidth (e.g., 80 MHz or beyond), millimeter wave (mmW) targeting high carrier frequency (e.g., 25 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe.

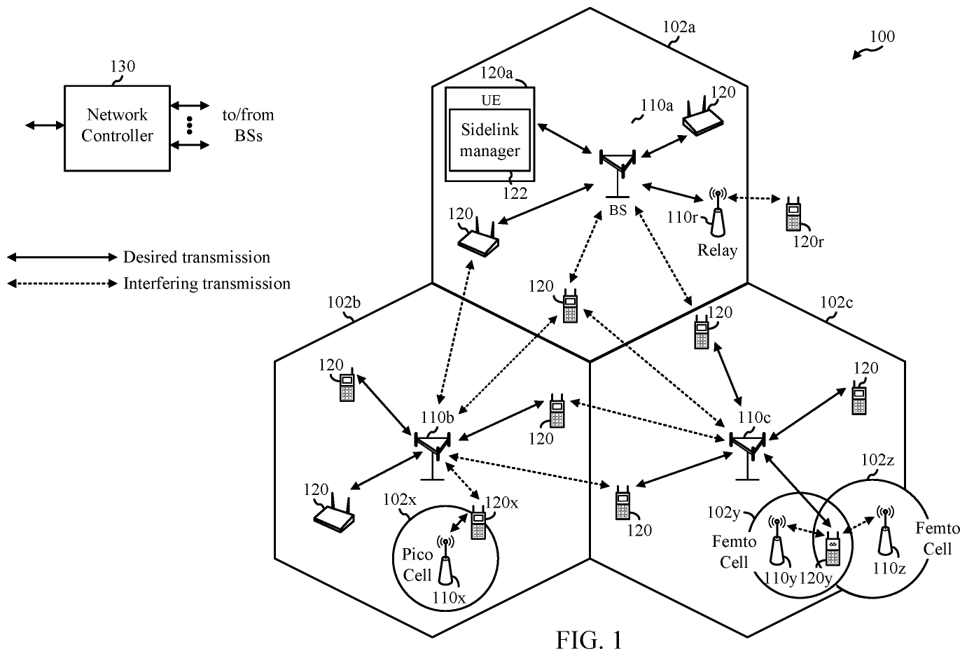

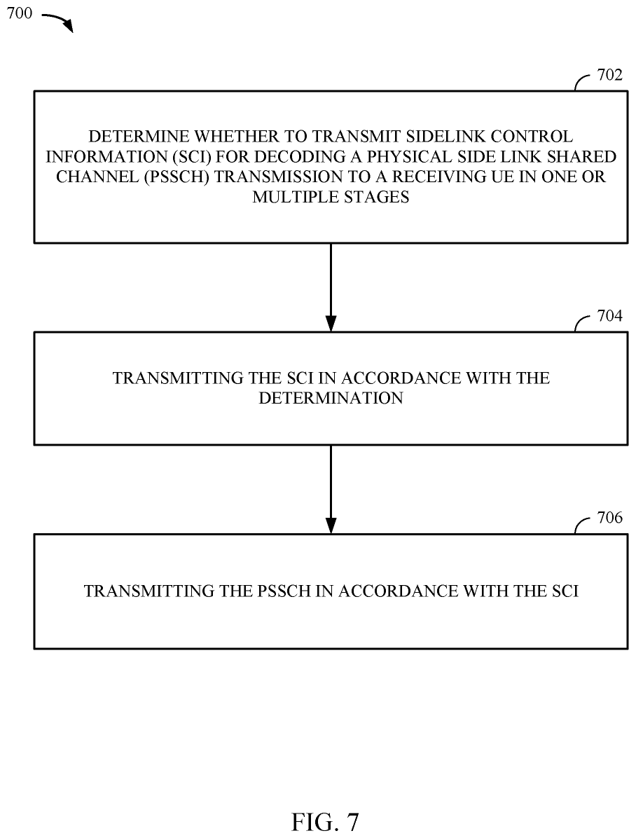

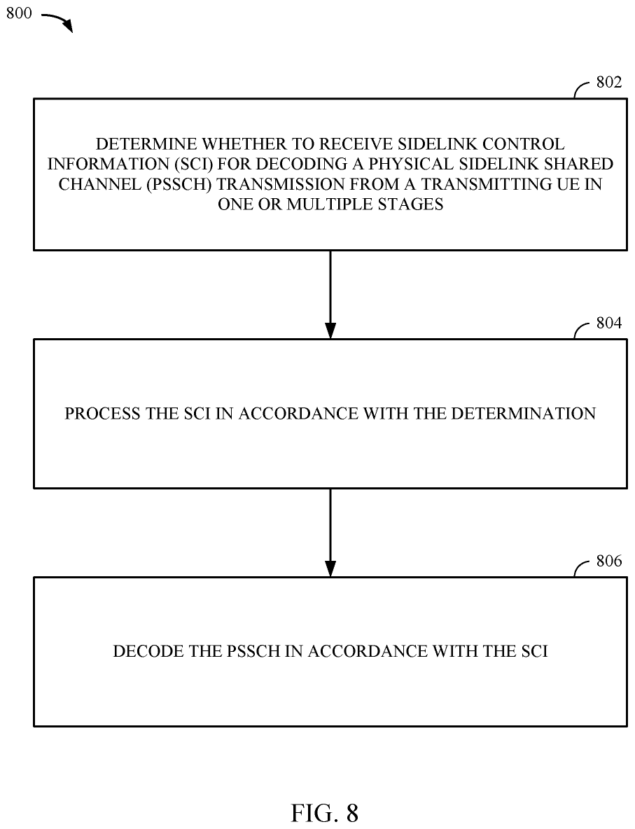

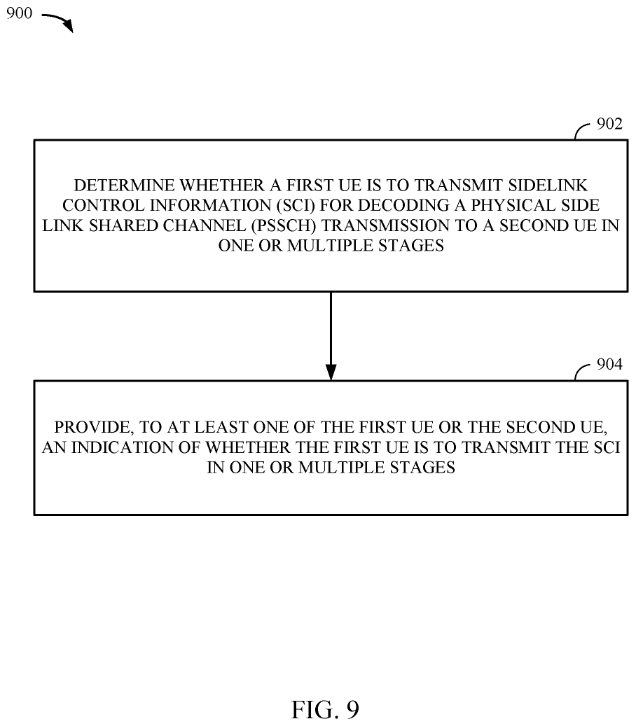

FIG. 1 illustrates an example wireless communication network 100 in which aspects of the present disclosure may be performed. For example, one or more UEs 120a of FIG. 1 may be configured to perform operations described below with reference to FIG. 7 to determine whether to transmit SCI for PSSCH transmission in one or multiple stages or FIG. 8 to determine how to process such SCI (and a corresponding physical sidelink shared channel). Similarly, a base station 110 may be configured to perform operations 900 of FIG. 9 to provide an indication of whether SCI should be transmitted in one or multiple stages.

As illustrated in FIG. 1, the wireless communication network 100 may include a number of base stations (BSs) 110a-z (each also individually referred to herein as BS 110 or collectively as BSs 110) and other network entities. In aspects of the present disclosure, a roadside service unit (RSU) may be considered a type of BS, and a BS 110 may be referred to as an RSU. A BS 110 may provide communication coverage for a particular geographic area, sometimes referred to as a “cell”, which may be stationary or may move according to the location of a mobile BS 110. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. ABS may support one or multiple cells. The BSs 110 communicate with user equipment (UEs) 120a-y (each also individually referred to herein as UE 120 or collectively as UEs 120) in the wireless communication network 100. The UEs 120 (e.g., 120x, 120y, etc.) may be dispersed throughout the wireless communication network 100, and each UE 120 may be stationary or mobile.

According to certain aspects, the UEs 120 may be configured to determine resources to use for sidelink communications (with another UE). As shown in FIG. 1, the UE 120a includes a sidelink manager 122. The sidelink manager 122 may be configured to transmit a sidelink communication to another UE, in accordance with aspects of the present disclosure (or to process such sidelink communications).

Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

A network controller 130 may couple to a set of BSs 110 and provide coordination and control for these BSs 110. The network controller 130 may communicate with the BSs 110 via a backhaul. The BSs 110 may also communicate with one another (e.g., directly or indirectly) via wireless or wireline backhaul.

The UEs 120 (e.g., 120x, 120y, etc.) may be dispersed throughout the wireless communication network 100, and each UE may be stationary or mobile. A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block” (RB)) may be 12 subcarriers (or 180 kHz). Consequently, the nominal Fast Fourier Transfer (FFT) size may be equal to 128, 256, 512, 1024 or 2048 for system bandwidth of 1.25, 2.5, 5, 10, or 20 megahertz (MHz), respectively. The system bandwidth may also be partitioned into subbands. For example, a subband may cover 1.8 MHz (i.e., 6 resource blocks), and there may be 1, 2, 4, 8, or 16 subbands for system bandwidth of 1.25, 2.5, 5, 10 or 20 MHz, respectively.

While aspects of the examples described herein may be associated with LTE technologies, aspects of the present disclosure may be applicable with other wireless communications systems, such as NR. NR may utilize OFDM with a CP on the uplink and downlink and include support for half-duplex operation using TDD. Beamforming may be supported and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

In FIG. 1, a solid line with double arrows indicates desired transmissions between a UE and a serving BS, which is a BS designated to serve the UE on the downlink and/or uplink. A finely dashed line with double arrows indicates interfering transmissions between a UE and a BS.

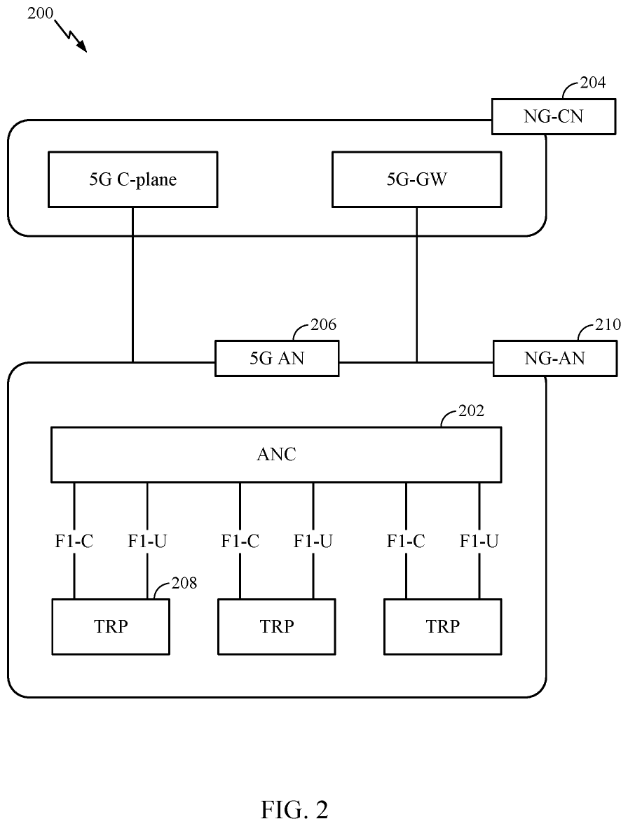

FIG. 2 illustrates an example logical architecture of a distributed Radio Access Network (RAN) 200, which may be implemented in the wireless communication network 100 illustrated in FIG. 1. A 5G access node 206 may include an access node controller (ANC) 202. ANC 202 may be a central unit (CU) of the distributed RAN 200. The backhaul interface to the Next Generation Core Network (NG-CN) 204 may terminate at ANC 202. The backhaul interface to neighboring next generation access Nodes (NG-ANs) 210 may terminate at ANC 202. ANC 202 may include one or more TRPs 208 (e.g., cells, BSs, gNBs, etc.).

The TRPs 208 may be a distributed unit (DU). TRPs 208 may be connected to a single ANC (e.g., ANC 202) or more than one ANC (not illustrated). For example, for RAN sharing, radio as a service (RaaS), and service specific AND deployments, TRPs 208 may be connected to more than one ANC. TRPs 208 may each include one or more antenna ports. TRPs 208 may be configured to individually (e.g., dynamic selection) or jointly (e.g., joint transmission) serve traffic to a UE.

The logical architecture of distributed RAN 200 may support fronthauling solutions across different deployment types. For example, the logical architecture may be based on transmit network capabilities (e.g., bandwidth, latency, and/or jitter).

The logical architecture of distributed RAN 200 may share features and/or components with LTE. For example, next generation access node (NG-AN) 210 may support dual connectivity with NR and may share a common fronthaul for LTE and NR.

The logical architecture of distributed RAN 200 may enable cooperation between and among TRPs 208, for example, within a TRP and/or across TRPs via ANC 202. An inter-TRP interface may not be used.

Logical functions may be dynamically distributed in the logical architecture of distributed RAN 200. The Radio Resource Control (RRC) layer, Packet Data Convergence Protocol (PDCP) layer, Radio Link Control (RLC) layer, Medium Access Control (MAC) layer, and a Physical (PHY) layers may be adaptably placed at the DU (e.g., TRP 208) or CU (e.g., ANC 202).

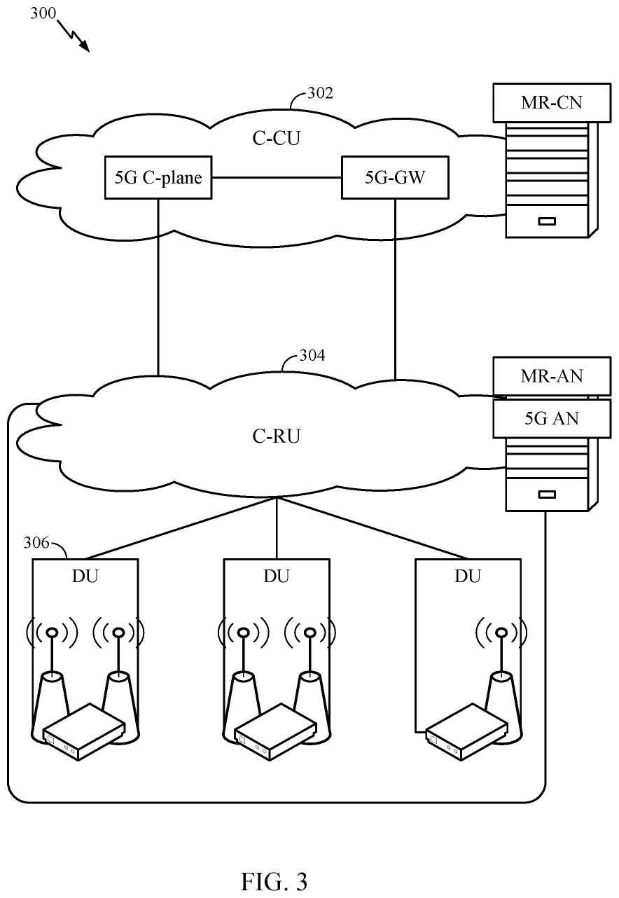

FIG. 3 illustrates an example physical architecture of a distributed RAN 300, according to aspects of the present disclosure. A centralized core network unit (C-CU) 302 may host core network functions. C-CU 302 may be centrally deployed. C-CU 302 functionality may be offloaded (e.g., to advanced wireless services (AWS)), in an effort to handle peak capacity.

A centralized RAN unit (C-RU) 304 may host one or more ANC functions. Optionally, the C-RU 304 may host core network functions locally. The C-RU 304 may have distributed deployment. The C-RU 304 may be close to the network edge.

A DU 306 may host one or more TRPs (Edge Node (EN), an Edge Unit (EU), a Radio Head (RH), a Smart Radio Head (SRH), or the like). The DU may be located at edges of the network with radio frequency (RF) functionality.

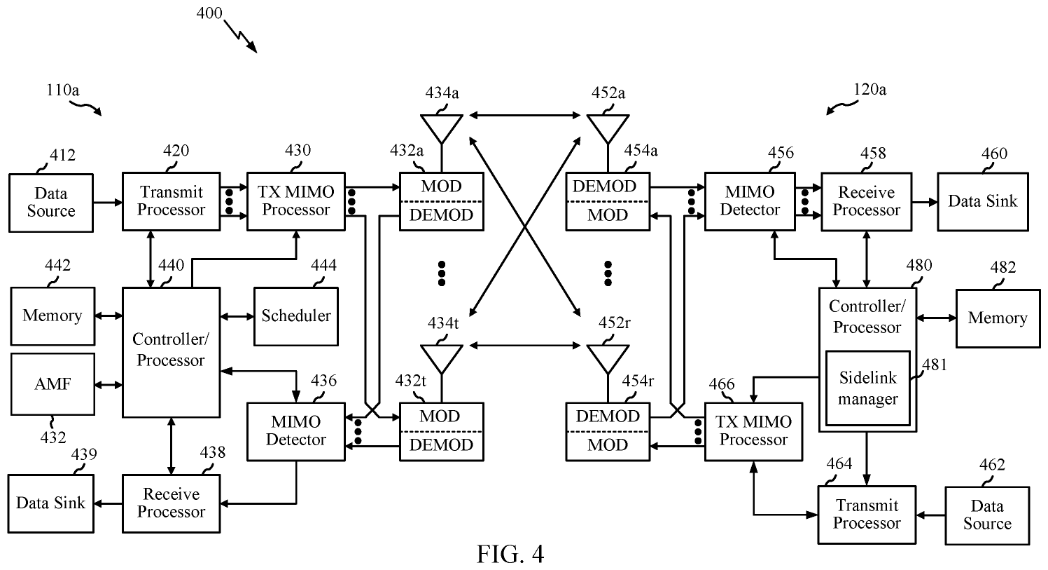

FIG. 4 illustrates example components of BS 110a and UE 120a (as depicted in FIG. 1), which may be used to implement aspects of the present disclosure. For example, antennas 452, processors 466, 458, 464, and/or controller/processor 480 of the UE 120a may be used to perform the various techniques and methods described herein with reference to FIG. 7 and/or FIG. 8. Similarly, antennas 434, processors 420, 438, 430, and/or controller/processor 440 of the BS 110a may be used to perform the various techniques and methods described herein with reference to FIG. 9.

At the BS 110a, a transmit processor 420 may receive data from a data source 412 and control information from a controller/processor 440. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. The processor 420 may process (e.g., encode and symbol map) the data and control information to obtain data symbols and control symbols, respectively. The processor 420 may also generate reference symbols, e.g., for the primary synchronization signal (PSS), secondary synchronization signal (SSS), and cell-specific reference signal (CRS). A transmit (TX) multiple-input multiple-output (MIMO) processor 430 may perform spatial processing (e.g., precoding) on the data symbols, the control symbols, and/or the reference symbols, if applicable, and may provide output symbol streams to the modulators (MODs) 432a through 432t. Each modulator 432 may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators 432a through 432t may be transmitted via the antennas 434a through 434t, respectively.

At the UE 120a, the antennas 452a through 452r may receive the downlink signals from the base station 110a and may provide received signals to the demodulators (DEMODs) in transceivers 454a through 454r, respectively. Each demodulator 454 may condition (e.g., filter, amplify, downconvert, and digitize) a respective received signal to obtain input samples. Each demodulator may further process the input samples (e.g., for OFDM, etc.) to obtain received symbols. A MIMO detector 456 may obtain received symbols from all the demodulators in transceivers 454a through 454r, perform MIMO detection on the received symbols if applicable, and provide detected symbols. A receive processor 458 may process (e.g., demodulate, deinterleave, and decode) the detected symbols, provide decoded data for the UE 120a to a data sink 460, and provide decoded control information to a controller/processor 480.

On the uplink, at UE 120a, a transmit processor 464 may receive and process data (e.g., for the physical uplink shared channel (PUSCH)) from a data source 462 and control information (e.g., for the physical uplink control channel (PUCCH) from the controller/processor 480. The transmit processor 464 may also generate reference symbols for a reference signal (e.g., for the sounding reference signal (SRS)). The symbols from the transmit processor 464 may be precoded by a TX MIMO processor 466 if applicable, further processed by the demodulators in transceivers 454a through 454r (e.g., for SC-FDM, etc.), and transmitted to the base station 110a. At the BS 110a, the uplink signals from the UE 120a may be received by the antennas 434, processed by the modulators 432, detected by a MIMO detector 436 if applicable, and further processed by a receive processor 438 to obtain decoded data and control information sent by the UE 120a. The receive processor 438 may provide the decoded data to a data sink 439 and the decoded control information to the controller/processor 440.

The controllers/processors 440 and 480 may direct the operation at the BS 110a and the UE 120a, respectively. The processor 440 and/or other processors and modules at the BS 110a may perform or direct the execution of processes for the techniques described herein. As shown in FIG. 2, the controller/processor 480 of the UE 120a has a sidelink manager 481 that may be configured for transmitting a sidelink communication to another UE (or for processing such sidelink communications). Although shown at the controller/processor 480 and controller/processor 440, other components of the UE 120a and BS 110a may be used performing the operations described herein. The memories 442 and 482 may store data and program codes for BS 110a and UE 120a, respectively. A scheduler 444 may schedule UEs for data transmission on the downlink, sidelink, and/or uplink.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks (WLANs), which typically use an unlicensed spectrum).

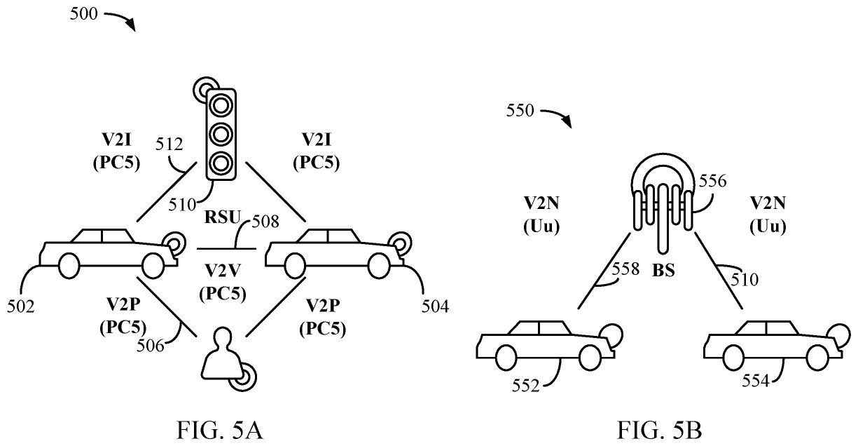

FIGS. 5A and 5B show diagrammatic representations of example vehicle to everything (V2X) systems in accordance with some aspects of the present disclosure. For example, the vehicles shown in FIGS. 5A and 5B may communicate via sidelink channels and may perform sidelink CSI reporting as described herein.

The V2X systems, provided in FIGS. 5A and 5B provide two complementary transmission modes. A first transmission mode, shown by way of example in FIG. 5A, involves direct communications (for example, also referred to as sidelink communications) between participants in proximity to one another in a local area. A second transmission mode, shown by way of example in FIG. 5B, involves network communications through a network, which may be implemented over a Uu interface (for example, a wireless communication interface between a radio access network (RAN) and a UE).

Referring to FIG. 5A, a V2X system 500 (for example, including vehicle-to-vehicle (V2V) communications) is illustrated with two vehicles 502, 504. The first transmission mode allows for direct communication between different participants in a given geographic location. As illustrated, a vehicle can have a wireless communication link 506 with an individual (i.e., vehicle to person (V2P), for example, via a UE) through a PC5 interface. Communications between the vehicles 502 and 504 may also occur through a PC5 interface 508. In a like manner, communication may occur from a vehicle 502 to other highway components (for example, roadside service unit 510), such as a traffic signal or sign (i.e., vehicle to infrastructure (V2I)) through a PC5 interface 512. With respect to each communication link illustrated in FIG. 5A, two-way communication may take place between elements, therefore each element may be a transmitter and a receiver of information. The V2X system 500 may be a self-managed system implemented without assistance from a network entity. A self-managed system may enable improved spectral efficiency, reduced cost, and increased reliability as network service interruptions do not occur during handover operations for moving vehicles. The V2X system may be configured to operate in a licensed or unlicensed spectrum, thus any vehicle with an equipped system may access a common frequency and share information. Such harmonized/common spectrum operations allow for safe and reliable operation.

FIG. 5B shows a V2X system 550 for communication between a vehicle 552 and a vehicle 554 through a network entity 556. These network communications may occur through discrete nodes, such as a base station (for example, an eNB or gNB), that sends and receives information to and from (for example, relays information between) vehicles 552, 554. The network communications through vehicle to network (V2N) links 558 and 510 may be used, for example, for long-range communications between vehicles, such as for communicating the presence of a car accident a distance ahead along a road or highway. Other types of communications may be sent by the node to vehicles, such as traffic flow conditions, road hazard warnings, environmental/weather reports, and service station availability, among other examples. Such data can be obtained from cloud-based sharing services.

In some circumstances, two or more subordinate entities (for example, UEs) may communicate with each other using sidelink signals. As described above, V2V and V2X communications are examples of communications that may be transmitted via a sidelink. When a UE is transmitting a sidelink communication on a sub-channel of a frequency band, the UE is typically unable to receive another communication (e.g., another sidelink communication from another UE) in the frequency band. Other applications of sidelink communications may include public safety or service announcement communications, communications for proximity services, communications for UE-to-network relaying, device-to-device (D2D) communications, Internet of Everything (IoE) communications, Internet of Things (IoT) communications, mission-critical mesh communications, among other suitable applications. Generally, a sidelink may refer to a direct link between one subordinate entity (for example, UE1) and another subordinate entity (for example, UE2). As such, a sidelink may be used to transmit and receive a communication (also referred to herein as a “sidelink signal”) without relaying the communication through a scheduling entity (for example, a BS), even though the scheduling entity may be utilized for scheduling or control purposes. In some examples, a sidelink signal may be communicated using a licensed spectrum (unlike wireless local area networks, which typically use an unlicensed spectrum).

Various sidelink channels may be used for sidelink communications, including a physical sidelink discovery channel (PSDCH), a physical sidelink control channel (PSCCH), a physical sidelink shared channel (PSSCH), and a physical sidelink feedback channel (PSFCH). The PSDCH may carry discovery expressions that enable proximal devices to discover each other. The PSCCH may carry control signaling such as sidelink resource configurations and other parameters used for data transmissions, and the PSSCH may carry the data transmissions.

For the operation regarding PSSCH, a UE performs either transmission or reception in a slot on a carrier. A reservation or allocation of transmission resources for a sidelink transmission is typically made on a sub-channel of a frequency band for a period of a slot. NR sidelink supports for a UE a case where all the symbols in a slot are available for sidelink, as well as another case where only a subset of consecutive symbols in a slot is available for sidelink.

PSFCH may carry feedback such as channel state information (CSI) related to a sidelink channel quality. A sequence-based PSFCH format with one symbol (not including AGC training period) may be supported. The following formats may be possible: a PSFCH format based on PUCCH format 2 and a PSFCH format spanning all available symbols for sidelink in a slot.

### Example Indication of Single-Stage or Multi-Stage Sidelink Control Information (SCI)

Aspects of the present disclosure provide techniques that may help save SCI overhead when a multi-stage SCI is not necessary. Different schemes are presented to indicate a presence or absence of a multi-stage SCI, such as a second stage SCI (SCI-2). The information or content that would have been otherwise carried in SCI-2 may still be carried using alternative mechanisms, even when a single stage SCI (SCI-1) is present and SCI-2 is absent.

As will be described in greater detail below, a transmitting UE may determine whether to transmit SCI for decoding a PSSCH transmission to a receiving UE in one or multiple stages. The transmitting UE then transmits the SCI in accordance with the determination and transmit the PSSCH in accordance with the SCI. As a result, the transmitting UE may determine to transmit SCI-1 without SCI-2, saving SCI overhead.

As will also be described in greater detail, the one or multi-stage SCI determination may be performed in either Mode 1 or Mode 2 sidelink communications. The network entity, in Mode 1 for example, may determine whether a first UE is to transmit SCI for decoding a PSSCH transmission to a second UE in one or multiple stages. The network entity may provide to at least one of the first UE or the second UE an indication of whether the first UE is to transmit the SCI in one or multiple stages.

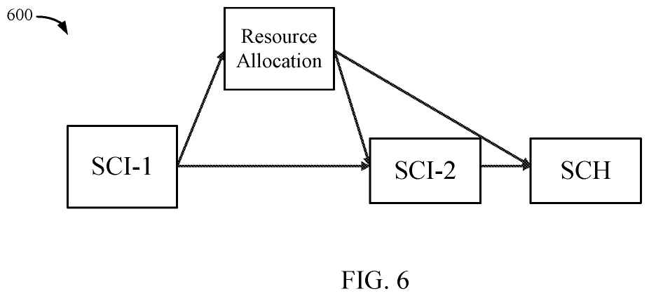

FIG. 6 illustrates an example two-stage SCI for sidelink communications 600, for which aspects of the present disclosure may be practiced. While the example of FIG. 6 shows two stages, the techniques presented herein may be applied generally to any number of multiple stages.

As shown, the first SCI stage (SCI-1) may be transmitted on PSCCH and contain information for resource allocation. SCI-1 may contain information for decoding SCI-2. The SCI-2 may be transmitted on PSSCH and contain information for decoding data (SCH). Both SCI-1 and SCI-2 may use the PDCCH polar code.

As noted above, NR sidelink generally has two modes of resource allocations: Mode 1 and Mode 2. In Mode 1, sidelink resources are scheduled by a gNb. In Mode 2, the UE may select sidelink resources from a sidelink resource pool based on channel sensing mechanisms.

Due to the need for resource sensing, not all fields of SCI may be transmitted in a single stage. A multi-stage SCI (such as SCI-1 and SCI-2) may be separately transmitted. SCI-1 may carry the information about the PSSCH resources and the information for decoding the SCI-2, including priority (QoS value), time-frequency resources of PSSCH/PSFCH, resource reservation period, PSSCH DMRS pattern, SCI-2 format, 2-bit beta offset for second stage control resource allocation, PSSCH DMRS port number, etc.

SCI-2 may carry the remaining scheduling information for the PSSCH decoding by the receiving UE, such as, for example, Source ID, Destination ID, channel state information (CSI) report trigger (unicast), modulation and coding scheme (MCS), UE-specific demodulation reference signal (DMRS), new data indicator (NDI), redundancy version (RV), hybrid automatic repeat request (HARQ) process ID, ZoneID of transmitter and maximum communication range of NACK (groupcast), etc.

It may be desirable to switch between single-stage and multi-stage SCI schemes. To support this, transmitting and receiving UEs may coordinate regarding the number of stages, for example, because SCI-2 decoding may need information in SCI-1, and data (PSSCH) decoding needs info in both SCI-1 and SCI-2.

Aspects of the present disclosure provide various techniques for indicating the number of SCI stages. For example, the techniques may indicate the presence or absence of SCI-2 and, if SCI-2 is absent, convey the information that would have been conveyed in SCI-2 via alternative mechanisms.

FIGS. 7, 8, and 9 illustrate example operations for such techniques from the perspective of a transmitting UE, a receiving UE, and a network entity, respectively.

FIG. 7 illustrates example operations 700 for wireless communications by a first transmitting UE, in accordance with certain aspects of the present disclosure. For example, operations 700 may be performed by a UE 120 of FIG. 1 or FIG. 4 when performing sidelink communications with a receiving UE (which may be another UE 120 of FIG. 1 or FIG. 4).

Operations 700 begin, at 702, by determining whether to transmit SCI for decoding a PSSCH transmission to a receiving UE in one or multiple stages. The determination may be based on different aspects in different options. For example, the determination may be based on a configuration (by a network entity or via sidelink) that indicates one or more stages for transmitting the SCI. In another option, the determination of whether to transmit SCI in one or multiple stages is based on a downlink control information (DCI) sent to the transmitting UE from a network entity. Details of such options and other options are further discussed below.

At 704, the transmitting UE transmits the SCI in accordance with the determination at 702. For example, the transmitting UE may transmit a single-stage or a multi-stage SCI based on a configuration or a DCI, or other determining factors, to the receiving UE.

At 706, the transmitting UE may transmit the PSSCH in accordance with the SCI. For example, the single-stage SCI, if so determined previously, would be sufficient for the receiving UE to decode the PSSCH transmitted at this step.

FIG. 8 illustrates example operations 800 for wireless communications by a receiving UE that may be considered complementary to operations 700 of FIG. 7. For example, operations 800 may be performed by another UE 120 of FIG. 1 or FIG. 4 for process SCI transmitted by the UE performing operations 700 of FIG. 7.

Operations 800 begin, at 802, by determining whether to receive SCI for decoding a PSSCH transmission from the transmitting UE in one or multiple stages. For example, the determination may correspond to various options based on configuration or DCI, as discussed related to the transmitting UE.

At 804, the receiving UE processes the SCI in accordance with the determination. For example, the receiving UE receives a single-stage or multi-stage SCI from the transmitting UE according to the previous determination and processes the received SCI.

At 806, the receiving UE decodes the PSSCH in accordance with the SCI.

As mentioned above, Release 16 has introduced a two-stage SCI, while future releases may allow for additional SCI stages (e.g., three or more stages). In the example of FIG. 6, SCI-1 and SCI-2 carry different information. Therefore, a determination of transmitting one or multiple stages (e.g., at respectively 702 and 802) may also include determining alternative mechanisms to transmit information that would have otherwise carried when multiple stage SCI is absent (i.e., when a single stage SCI is determined). Example alternative mechanisms are discussed below. In some implementations, each of the one or multiple SCI stages involves transmitting SCI in a single packet.

In one option, the determination may be based on a configuration that indicates one or more stages for transmitting the SCI. For example, the configuration indicates that the number of SCI stages is one or two. The configuration may be conveyed via a radio resource control (RRC) or medium access control (MAC) control element (CE) signaling. For example, the configuration may be received from a network entity, such as in Mode 1 of sidelink transmission. In other cases, the configuration may be conveyed via a sidelink RRC. The MAC CE may be a sidelink MAC CE.

In some aspects, the configuration may expire in a set period of time or until receiving further configuration. For example, when the configuration is time limited, the configuration may apply for the next set number of subframes or next set number of instances or periods of the resource pool. In other cases, the configuration may hold until changed.

In some embodiments, an indication may be provided to the receiving UE, in the first SCI transmission, of whether the SCI is transmitted in one or multiple stages. For example, the transmitting UE may use the first SCI transmission to indicate a presence or absence of a second (or more) SCI transmission(s). In some cases, the indication may be implicit in the first SCI transmission based on a format of the first SCI or values of one or more fields in the SCI. In some cases, the SCI format itself may be RRC configured. For example, the first SCI may indicate a size of PSSCH resource allocation that is not sufficient for providing a second SCI, therefore indicating an absence of any subsequent transmission. In some cases, the implicit indication may be based on a destination address. For example, in relaying cases, if a packet is transmitted from A to B and has B as the destination, then no second SCI is to be transmitted. By comparison, if the packet has C as the destination, then B may read a second SCI in order to determine grant parameters for the transmission from B to C.

In other situations, the first SCI may provide an explicit field or bit to indicate the presence of a second or subsequent SCI, such as, for example, using a “SCI-2 Presence” field.

In another option, the determination of whether to transmit SCI in one or multiple stages is based on a downlink control information (DCI) sent to the transmitting UE from a wireless network entity. In some embodiments, the receiving UE is informed about the SCI stage determination by the wireless network entity. For example, in Mode 1, grant DCI may tell the sidelink transmitting UE to send only SCI-1. The sidelink receiving UE may be informed about this determination according to various embodiments presented herein. In addition or alternatively, the wireless network may send a “Mode 1 Rx grant” or a similar indication to the receiving UE to inform the receiving UE.

In other embodiments, the determination may be applied to sidelink communications per link, per resource pool, or per specific subset of resource pool. For example, the determination may be applied based on one or more of the time-domain allocation (e.g., slot or subframe index), frequency domain allocation (e.g., subchannel index), or spatial allocation (e.g., beam index).

Although the aforementioned multiple stages are illustrated using SCI-1 and SCI-2, a third, fourth, and subsequent SCI stages may be configured, determined, and indicated according to various embodiments of the present disclosure. For example, a third SCI stage may carry additional information (e.g., relayed grant for use in the next hop) to the SCI-2. The presence or absence of the third SCI may be indicated in a combination of RRC and indications in SCI-1 and SCI-2. Similarly, the disclosed methods apply to multi-packet situations. For example, SCI-2 may be split into multiple parts and the indication of SCI stages may apply to a number of subframes corresponding to the same number of the multiple parts of the split SCI-2.

When the second or subsequent SCI stages are absent, the sidelink communication may still carry, with a single stage SCI, information that would have been carried in multiple stage SCI situations. For example, when the transmitting UE determines to transmit SCI in a single stage, the single stage SCI may include information that would have been carried in at least a second stage if the SCI were transmitted in multiple stages. For example, the single stage SCI may include new fields to carry the information that would have been carried. Alternatively, the single stage SCI may re-use the fields that was used to indicate the second SCI stage, or a combination of new fields and re-using the fields used to indicate the second SCI stage.

In some cases, the single stage SCI may include fields of one or more of a new data indicator (NDI), hybrid automatic repeat request (HARQ) process identifier (Id), source ID, destination ID, or CSI report trigger. In other cases, the information that would have been carried in at least a second stage if the SCI were transmitted in multiple stages is conveyed via RRC or MAC CE signaling. For example, as RRC, MAC CE, or DCI may indicate the absence of the second or subsequent SCIs, the RRC, MAC CE, or DCI may also specify the information that could have been carried in the second or subsequent SCIs.

In some cases, the information that would have been carried in at least a second stage if the SCI were transmitted in multiple stages is derived from information in the single stage SCI implicitly. For example, the HARQ process ID may be derived from a slot or subframe number.

In other cases, default values may be assumed for information that would have been carried in at least a second stage if the SCI were transmitted in multiple stages is derived from information in the single stage SCI. For example, in a Uu link, some fields of the second SCI that would have been transmitted may be supported only in a long DCI, thus comparing a short DCI to a long DCI can indicate default values (e.g., format 0_0 vs. 0_1 for uplink, or 1_0 vs. 1_1 for downlink). Similar approaches may apply for default maximum communication range for group-based NACK. In other instances, the code block group (CBG) transmission information or CBG flushing out information (CBGTI/CBGFI) fields are not in the short DCI because CBG-based HARQ is not supported in short DCIs. Similarly, distance-based NACK may not be supported if the maximum communication range field is missing in the absence of the second SCI stage.

As noted above, in some cases, a network entity may indicate to a transmitting UE, receiving UE, or both, whether SCI will be transmitted in one or multiple stages.

FIG. 9 illustrates example operations 900 for wireless communications by a network to provide such an indication. For example, operations 900 may be performed by a wireless network entity 556 of FIG. 5 (which could be a base station 110 of FIG. 1 or FIG. 4) when supporting sidelink communications between a transmitting UE and a receiving UE, such as the operations 700 and 800 described above.

Operations 900 begin, at 902, by determining whether a transmitting UE is to transmit SCI for decoding a PSSCH transmission to a receiving UE in one or multiple stages. The wireless network entity may provide, at 904, an indication of whether the transmitting US is to transmit the SCI in one or multiple stages to at least one of the transmitting UE or the receiving UE. As mentioned above, the indication may be provided via a DCI, which may include at least one of a transmit grant to the transmitting UE, or a receive grant to the receiving UE.

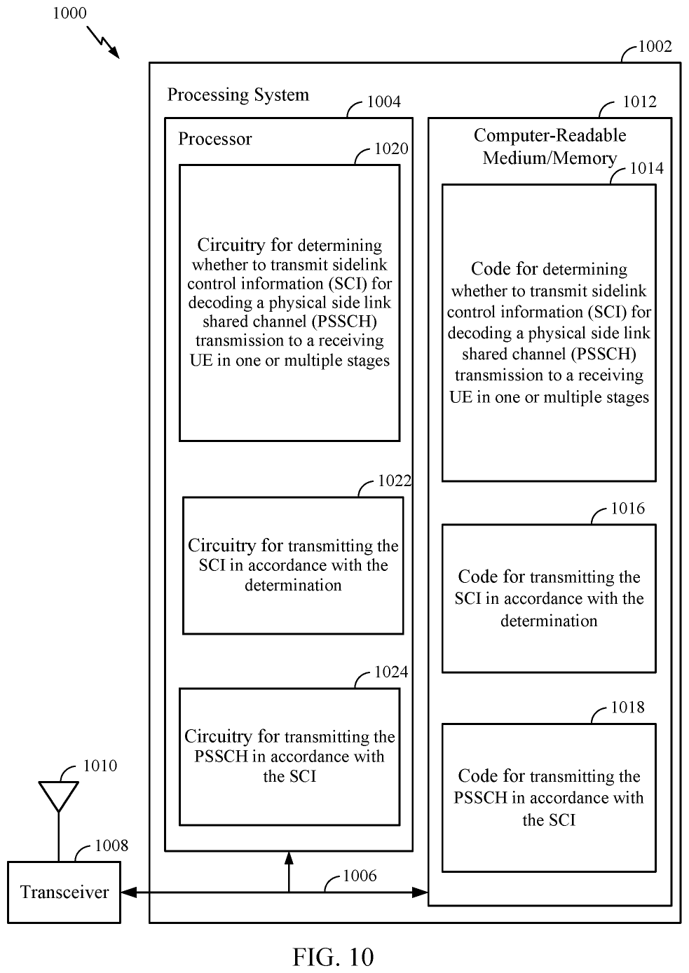

FIG. 10 illustrates a communications device 1000 that may include various components (e.g., corresponding to means-plus-function components) configured to perform operations for the techniques disclosed herein, such as the operations illustrated in FIG. 7. The communications device 1000 includes a processing system 1002 coupled to a transceiver 1008. The transceiver 1008 is configured to transmit and receive signals for the communications device 1000 via an antenna 1010, such as the various signals as described herein. The processing system 1002 may be configured to perform processing functions for the communications device 1000, including processing signals received and/or to be transmitted by the communications device 1000.

The processing system 1002 includes a processor 1004 coupled to a computer-readable medium/memory 1012 via a bus 1006. In certain aspects, the computer-readable medium/memory 1012 is configured to store instructions (e.g., computer-executable code) that when executed by the processor 1004, cause the processor 1004 to perform the operations illustrated in FIG. 7, or other operations for recovering a sidelink communication that is missed by a wireless node due to the wireless node transmitting while the sidelink communication is occurring. In certain aspects, computer-readable medium/memory 1012 stores code 1014 for determining whether to transmit SCI for decoding a PSSCH transmission to a receiving UE in one or multiple stages; code 1016 for transmitting the SCI in accordance with the determination; and code 1018 for transmitting the PSSCH in accordance with the SCI. In certain aspects, the processor 1004 has circuitry configured to implement the code stored in the computer-readable medium/memory 1012. The processor 1004 includes circuitry 1020 for determining whether to transmit SCI for decoding a PSSCH transmission to a receiving UE in one or multiple stages; circuitry 1022 for transmitting the SCI in accordance with the determination; and circuitry 1024 for transmitting the PSSCH in accordance with the SCI.

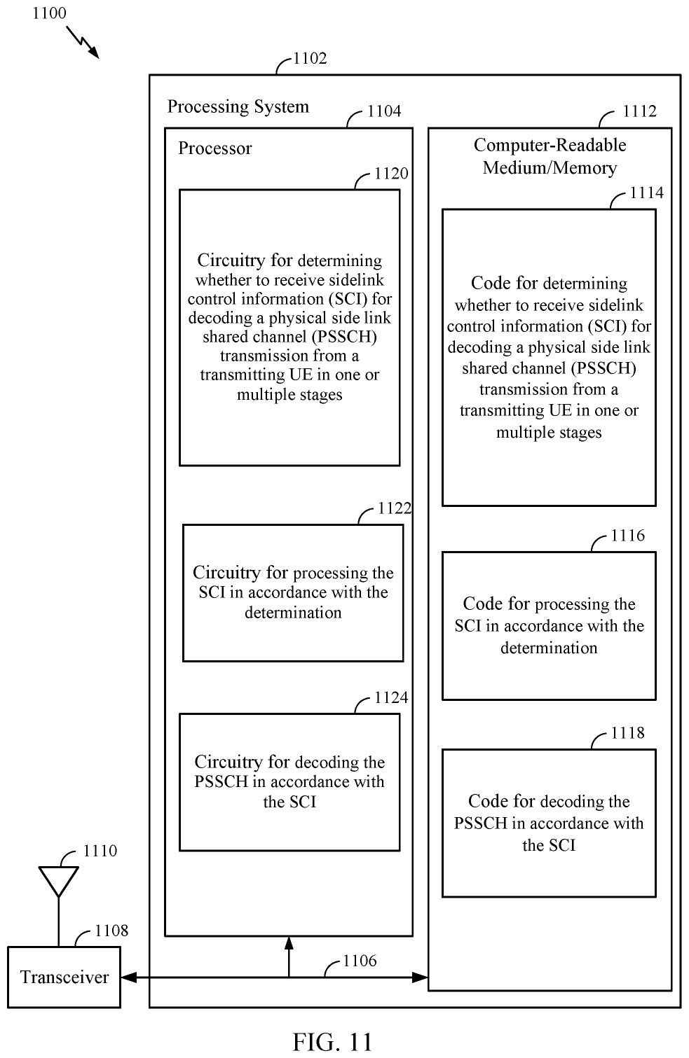

FIG. 11 illustrates a communications device 1100 that may include various components (e.g., corresponding to means-plus-function components) configured to perform operations for the techniques disclosed herein, such as the operations illustrated in FIG. 8. The communications device 1100 includes a processing system 1102 coupled to a transceiver 1108. The transceiver 1108 is configured to transmit and receive signals for the communications device 1100 via an antenna 1110, such as the various signals as described herein. The processing system 1102 may be configured to perform processing functions for the communications device 1100, including processing signals received and/or to be transmitted by the communications device 1100.

The processing system 1102 includes a processor 1104 coupled to a computer-readable medium/memory 1112 via a bus 1106. In certain aspects, the computer-readable medium/memory 1112 is configured to store instructions (e.g., computer-executable code) that when executed by the processor 1104, cause the processor 1104 to perform the operations illustrated in FIG. 8, or other operations for recovering a sidelink communication that is missed by a wireless node due to the wireless node transmitting while the sidelink communication is occurring. In certain aspects, computer-readable medium/memory 1112 stores code 1114 for determining whether to receive SCI for decoding a PSSCH transmission from a transmitting UE in one or multiple stages; code 1116 for processing the SCI in accordance with the determination; and code 1118 for decoding the PSSCH in accordance with the SCI. In certain aspects, the processor 1104 has circuitry configured to implement the code stored in the computer-readable medium/memory 1112. The processor 1104 includes circuitry 1120 for determining whether to receive SCI for decoding a PSSCH transmission from a transmitting UE in one or multiple stages; circuitry 1122 for processing the SCI in accordance with the determination; and circuitry 1124 for decoding the PSSCH in accordance with the SCI.

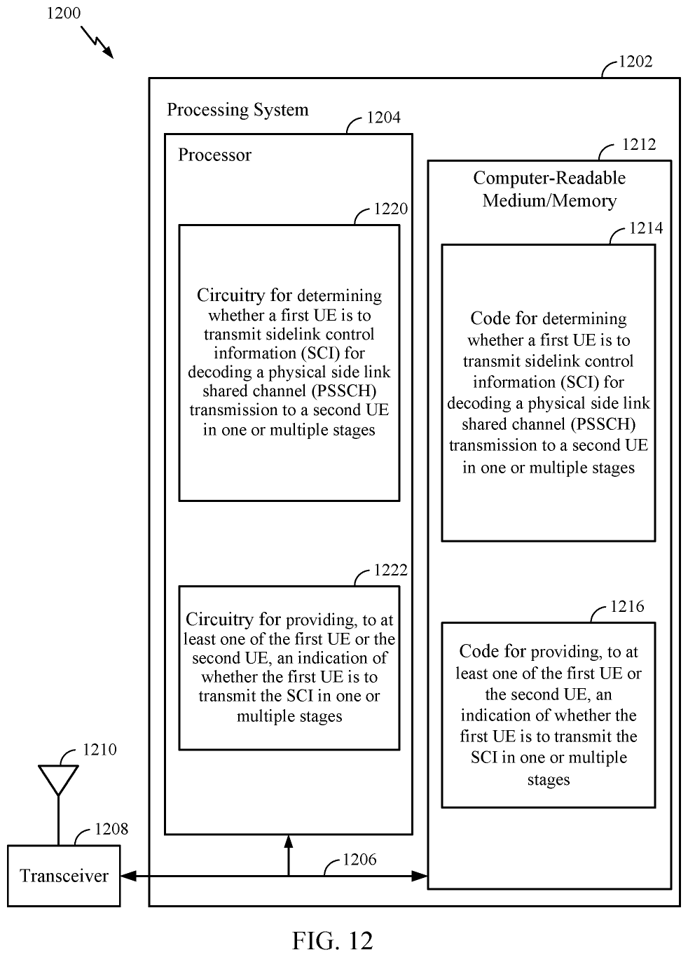

FIG. 12 illustrates a communications device 1200 that may include various components (e.g., corresponding to means-plus-function components) configured to perform operations for the techniques disclosed herein, such as the operations illustrated in FIG. 9. The communications device 1200 includes a processing system 1202 coupled to a transceiver 1208. The transceiver 1208 is configured to transmit and receive signals for the communications device 1200 via an antenna 1210, such as the various signals as described herein. The processing system 1202 may be configured to perform processing functions for the communications device 1200, including processing signals received and/or to be transmitted by the communications device 1200.

The processing system 1202 includes a processor 1204 coupled to a computer-readable medium/memory 1212 via a bus 1206. In certain aspects, the computer-readable medium/memory 1212 is configured to store instructions (e.g., computer-executable code) that when executed by the processor 1204, cause the processor 1204 to perform the operations illustrated in FIG. 9, or other operations for recovering a sidelink communication that is missed by a wireless node due to the wireless node transmitting while the sidelink communication is occurring. In certain aspects, computer-readable medium/memory 1212 stores code 1214 for determining whether a first UE is to transmit SCI for decoding a PSSCH transmission to a second UE in one or multiple stages; and code 1216 for providing, to at least one of the first UE or the second UE, an indication of whether the first UE is to transmit the SCI in one or multiple stages. In certain aspects, the processor 1204 has circuitry configured to implement the code stored in the computer-readable medium/memory 1212. The processor 1204 includes circuitry 1220 for determining whether a first UE is to transmit SCI for decoding a PSSCH transmission to a second UE in one or multiple stages; and circuitry 1222 for providing, to at least one of the first UE or the second UE, an indication of whether the first UE is to transmit the SCI in one or multiple stages.

### Example Aspects

Aspect 1: A method for wireless communication by a transmitting user equipment (UE), comprising: determining whether to transmit sidelink control information (SCI) for decoding a physical sidelink shared channel (PSSCH) transmission to a receiving UE in one or multiple stages; transmitting the SCI in accordance with the determination; and transmitting the PSSCH in accordance with the SCI.

Aspect 2: The method of aspect 1, wherein the determination is based on a configuration that indicates one or more stages for transmitting the SCI.

Aspect 3: The method of aspect 2, wherein the configuration is conveyed via a radio resource control (RRC) or medium access control (MAC) control element (CE) signaling.

Aspect 4: The method of aspect 2 or 3, wherein the configuration is received from a network entity.

Aspect 5: The method of aspect 2 or 3, wherein the configuration is conveyed via sidelink RRC.

Aspect 6: The method of aspect 2 or 3, wherein the configuration expires in a set period of time or until receiving further configuration.

Aspect 7: The method of aspect 2 or 3, wherein the configuration indicates a number of SCI stages.

Aspect 8: The method of aspect 1, further comprising providing, in a first SCI transmission, an indication to the receiving UE of whether the SCI is transmitted in one or multiple stages.

Aspect 9: The method of aspect 8, wherein the indication is implicit in the first SCI transmission based on a format of the first SCI or values of one or more fields in the first SCI.

Aspect 10: The method of aspect 9, wherein the implicit indication is based on a destination address.

Aspect 11: The method of aspect 8, wherein the first SCI comprises an explicit indication of whether the SCI is transmitted in one or multiple stages.

Aspect 12: The method of aspect 1 or 2, wherein the determination is based on a downlink control information (DCI) sent to the transmitting UE from a wireless network entity.

Aspect 13: The method of aspect 12, wherein the receiving UE is informed about the SCI stage determination by the wireless network entity.

Aspect 14: The method of aspect 1, wherein the determination is applied to sidelink communications per link, per resource pool, or per specific subset of resource pool.

Aspect 15: The method of aspect 1, wherein the determination is to transmit SCI in a single stage.

Aspect 16: The method of aspect 15, wherein the single stage SCI includes information that would have been carried in at least a second stage if the SCI were transmitted in multiple stages.

Aspect 17: The method of aspect 15, wherein the single stage SCI includes fields of one or more of a new data indicator (NDI), hybrid automatic repeat request (HARM) process identifier (ID), source ID, destination ID, or channel state information (CSI) report trigger.

Aspect 18: The method of aspect 15, wherein information that would have been carried in at least a second stage if the SCI were transmitted in multiple stages is conveyed via radio resource control (RRC) or medium access control (MAC) control element (CE) signaling.

Aspect 19: The method of aspect 15, wherein information that would have been carried in at least a second stage if the SCI were transmitted in multiple stages is derived from information in the single stage SCI.

Aspect 20: The method of aspect 15, wherein default values are assumed for information that would have been carried in at least a second stage if the SCI were transmitted in multiple stages is derived from information in the single stage SCI.

Aspect 21: The method of aspect 1, wherein each of the one or multiple SCI stages involves transmitting SCI in a single packet.

Aspect 22: A method for wireless communication by a receiving user equipment (UE), comprising: determining whether to receive sidelink control information (SCI) for decoding a physical sidelink shared channel (PSSCH) transmission from a transmitting UE in one or multiple stages; processing the SCI in accordance with the determination; and decoding the PSSCH in accordance with the SCI.

Aspect 23: The method of aspect 22, wherein the determination is based on a configuration that indicates one or more stages for transmitting the SCI.

Aspect 24: The method of aspect 23, wherein the configuration is conveyed via a radio resource control (RRC) or medium access control (MAC) control element (CE) signaling.

Aspect 25: The method of aspect 24, wherein the configuration is received from a network entity.

Aspect 26: The method of aspect 24, wherein the configuration is conveyed via sidelink RRC.

Aspect 27: The method of aspect 23, wherein the configuration expires in a set period of time or until receiving further configuration.

Aspect 28: The method of aspect 24, wherein the configuration indicates that the number of SCI stages is one or two.

Aspect 29: The method of aspect 22, further comprising providing, in a first SCI transmission, an indication to the receiving UE of whether the SCI is transmitted in one or multiple stages.

Aspect 30: The method of aspect 29, wherein the indication is implicit in the first SCI transmission based on a format of the first SCI or values of one or more fields in the first SCI.

Aspect 31: The method of aspect 30, wherein the implicit indication is based on a destination address.

Aspect 32: The method of aspect 29, wherein the first SCI comprises an explicit indication of whether the SCI is transmitted in one or multiple stages.

Aspect 33: The method of aspect 23, wherein the determination is based on a downlink control information (DCI) sent to the transmitting UE from a network entity.

Aspect 34: The method of aspect 33, wherein the receiving UE is informed about the SCI stage determination by the wireless network entity.

Aspect 35: The method of aspect 22, wherein the determination is applied to sidelink communications per link, per resource pool, or per specific subset of resource pool.

Aspect 36: The method of aspect 22, wherein the determination is to transmit SCI in a single stage.

Aspect 37: The method of aspect 36, wherein the single stage SCI includes information that would have been carried in at least a second stage if the SCI were transmitted in multiple stages.

Aspect 38: The method of aspect 36, wherein the single stage SCI includes fields of one or more of a new data indicator (NDI), hybrid automatic repeat request (HARM) process identifier (ID), source ID, destination ID, or channel state information (CSI) report trigger.

Aspect 39: The method of aspect 36, wherein information that would have been carried in at least a second stage if the SCI were transmitted in multiple stages is conveyed via radio resource control (RRC) or medium access control (MAC) control element (CE) signaling.

Aspect 40: The method of aspect 36, wherein information that would have been carried in at least a second stage if the SCI were transmitted in multiple stages is derived from information in the single stage SCI.

Aspect 41: The method of aspect 36, wherein default values are assumed for information that would have been carried in at least a second stage if the SCI were transmitted in multiple stages is derived from information in the single stage SCI.

Aspect 42: The method of aspect 22, wherein each of the one or multiple SCI stages involves transmitting SCI in a single packet.

Aspect 43: A method for wireless communication by a network entity, comprising: determining whether a first UE is to transmit sidelink control information (SCI) for decoding a physical sidelink shared channel (PSSCH) transmission to a second UE in one or multiple stages; and providing, to at least one of the first UE or the second UE, an indication of whether the first UE is to transmit the SCI in one or multiple stages.

Aspect 44: The method of aspect 43, wherein the indication is provided via a downlink control information (DCI).

Aspect 45: The method of aspect 44, wherein the DCI comprises at least one of: a transmit grant to the first UE; or a receive grant to the second UE.

Aspect 46: An apparatus for wireless communications by a transmitting user equipment (UE), comprising: means for determining whether to transmit sidelink control information (SCI) for decoding a physical sidelink shared channel (PSSCH) transmission to a receiving UE in one or multiple stages; means for transmitting the SCI in accordance with the determination; and means for transmitting the PSSCH in accordance with the SCI.

Aspect 47: An apparatus for wireless communications by a receiving user equipment (UE), comprising: means for determining whether to receive sidelink control information (SCI) for decoding a physical sidelink shared channel (PSSCH) transmission from a transmitting UE in one or multiple stages; means for processing the SCI in accordance with the determination; and means for decoding the PSSCH in accordance with the SCI.

Aspect 48: An apparatus for wireless communications by a network entity, comprising: means for determining whether a first UE is to transmit sidelink control information (SCI) for decoding a physical sidelink shared channel (PSSCH) transmission to a second UE in one or multiple stages; and means for providing, to at least one of the first UE or the second UE, an indication of whether the first UE is to transmit the SCI in one or multiple stages.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing, and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components. For example, various operations shown in FIGS. 7, 8 and/or 9 may be performed by various processors shown in FIG. 4 for UE 120a and/or BS 110a.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For example, instructions for performing the operations described herein and illustrated in FIGS. 7-9.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation and details of the methods and apparatus described above without departing from the scope of the claims.

What is claimed is:

1. A method for wireless communication by a transmitting user equipment (UE), comprising:
determining whether to transmit sidelink control information (SCI) for decoding a physical sidelink shared channel (PSSCH) transmission to a receiving UE in one or multiple stages;
transmitting the SCI in accordance with the determination; and
transmitting the PSSCH in accordance with the SCI.

2. The method of claim 1, wherein the determination is based on a configuration that indicates one or more stages for transmitting the SCI.

3. The method of claim 2, wherein the configuration is conveyed via a radio resource control (RRC) or medium access control (MAC) control element (CE) signaling.

4. The method of claim 3, wherein the configuration is received from a network entity.

5. The method of claim 3, wherein the configuration is conveyed via sidelink RRC.

6. The method of claim 3, wherein the configuration indicates that the number of SCI stages is one or two.

7. The method of claim 2, wherein the configuration expires in a set period of time or until receiving further configuration.

8. The method of claim 2, wherein the determination is based on a downlink control information (DCI) sent to the transmitting UE from a wireless network entity.

9. The method of claim 1, further comprising providing, in a first SCI transmission, an indication to the receiving UE of whether the SCI is transmitted in one or multiple stages.

10. The method of claim 1, wherein the determination is applied to sidelink communications per link, per resource pool, or per specific subset of resource pool.

11. The method of claim 1, wherein the determination is to transmit SCI in a single stage.

12. The method of claim 11, wherein the single stage SCI includes information that would have been carried in at least a second stage if the SCI were transmitted in multiple stages.

13. The method of claim 11, wherein the single stage SCI includes fields of one or more of a new data indicator (NDI), hybrid automatic repeat request (HARM) process identifier (ID), source ID, destination ID, or channel state information (CSI) report trigger.

14. The method of claim 11, wherein information that would have been carried in at least a second stage if the SCI were transmitted in multiple stages is conveyed via radio resource control (RRC) or medium access control (MAC) control element (CE) signaling.

15. The method of claim 11, wherein information that would have been carried in at least a second stage if the SCI were transmitted in multiple stages is derived from information in the single stage SCI.

16. The method of claim 11, wherein default values are assumed for information that would have been carried in at least a second stage if the SCI were transmitted in multiple stages is derived from information in the single stage SCI.

17. The method of claim 1, wherein each of the one or multiple SCI stages involves transmitting SCI in a single packet.

18. A method for wireless communication by a receiving user equipment (UE), comprising:
determining whether to receive sidelink control information (SCI) for decoding a physical sidelink shared channel (PSSCH) transmission from a transmitting UE in one or multiple stages;
processing the SCI in accordance with the determination; and
decoding the PSSCH in accordance with the SCI.

19. The method of claim 18, wherein the determination is based on a configuration that indicates one or more stages for transmitting the SCI.

20. The method of claim 19, wherein the configuration is conveyed via a radio resource control (RRC) or medium access control (MAC) control element (CE) signaling.

21. The method of claim 19, wherein the configuration expires in a set period of time or until receiving further configuration.

22. The method of claim 20, wherein the configuration indicates that the number of SCI stages is one or two.

23. The method of claim 18, further comprising providing, in a first SCI transmission, an indication to the receiving UE of whether the SCI is transmitted in one or multiple stages.

24. The method of claim 18, wherein the determination is applied to sidelink communications per link, per resource pool, or per specific subset of resource pool.

25. The method of claim 18, wherein the determination is to transmit SCI in a single stage.

26. The method of claim 18, wherein each of the one or multiple SCI stages involves transmitting SCI in a single packet.

27. A method for wireless communication by a network entity, comprising:
determining whether a first UE is to transmit sidelink control information (SCI) for decoding a physical sidelink shared channel (PSSCH) transmission to a second UE in one or multiple stages; and
providing, to at least one of the first UE or the second UE, an indication of whether the first UE is to transmit the SCI in one or multiple stages.

28. The method of claim 27, wherein the indication is provided via a downlink control information (DCI).

29. The method of claim 28, wherein the DCI comprises at least one of:
a transmit grant to the first UE; or
a receive grant to the second UE.

30. An apparatus for wireless communications by a network entity, comprising:
means for determining whether a first UE is to transmit sidelink control information (SCI) for decoding a physical sidelink shared channel (PSSCH) transmission to a second UE in one or multiple stages; and
means for providing, to at least one of the first UE or the second UE, an indication of whether the first UE is to transmit the SCI in one or multiple stages.
